(19) United States
(12) Patent Application Publication
(10) Pub. No.: US 2005/0189721 A1
(43) Pub. Date: Sep. 1, 2005

(54) Seal arrangement

(75) Inventor: Bernhard Feldmann, Wermelskirchen (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AB SKF, Goteborg (SE)

(21) Appl. No.: 11/045,152

(22) Filed: Jan. 31, 2005

(30) Foreign Application Priority Data
Jan. 31, 2004 (DE) 10 2004 004 938.6

(51) Int. Cl. F16J 15/34

(52) U.S. Cl. 277/358

(57) ABSTRACT

The invention relates to a seal arrangement which has a seal element with at least one seal lip and at lest one support ring with which the seal element is supported. To simplify installation of the seal arrangement, the support ring at least at one peripheral point has at least one notch which weakens the annular cross section.

### BACKGROUND OF THE INVENTION

The invention relates to a seal arrangement which has a seal element with at least one seal lip and at least one support ring with which the seal element is supported.

A seal arrangement of the generic type is known for example from U.S. Pat. No. 5,332,234, the disclosure of which is hereby incorporated by reference. A seal element of elastomer plastic disclosed in that document has a seal lip. The seal element itself borders the support ring which consists of harder material (in this case polytetrafluorethylene) and which keeps the relatively soft seal element in position.

These seal arrangements with a seal element together with the support ring are often used in steering assemblies, especially as rack seals. The support ring is designed to support the pressurized membrane of the seal arrangement. The support rings which are used are generally buttoned in on the bottom of the seal element. The support rings are made either as a closed ring or are slit at a peripheral point in order to enable installation. The inside diameter of the support ring is only minimally larger, for example 0.2 mm, than the diameter of the shaft on which the seal arrangement is placed. This is necessary to keep the seal element reliably in position and to prevent its being squeezed through the annular gap between the support ring and the shaft.

In many cases, for installation purposes the seal arrangement must be pushed over a section on which the shaft which is to be sealed is located. To protect the seal lip of the seal element against damage, protective sleeves are often pushed over the locations. The outside diameter of the protective sleeve is greater than the inside diameter of the closed support ring, for which reason it cannot be installed. In this case, it is necessary to use a support ring having a slit which as a result of the slit at one peripheral point allows widening in order to be able to push it over the protective sleeve.

Depending on the position of the slit on the periphery of the support ring, the support rings can interlock with one another as they are being handled. This is especially apparent when support rings which are normally supplied as bulk material must be mounted. Handling of the individual parts of the seal arrangement is made more difficult thereby.

Therefore, as an alternative possibility, transporting closed support rings to the installation site and splitting or breaking through them directly before installation in an automatic installation device were considered. The disadvantage in this concept is that when the support ring is cut by means of a saw, dust is formed which entails the corresponding encumbrance of the workplace. When the support rings are cut by means of a knife very large forces are required, for which reason maintenance costs for the knife are high. When the support ring is broken through, ultimately it must be taken into account whether the support ring can tilt later at the breaking point in a disadvantageous manner or that larger segments break away entirely.

### OBJECTS AND SUMMARY OF THE INVENTION

It is an object of this invention to avoid or alleviate the problems of the prior art.

It is also an object of the invention is to make a seal arrangement of the genetic type such that the support ring can perform its function without limitations, but there are no limitations at all during transport and when handling the support rings, and mounting of the seal arrangement can be managed very easily.

These and other objects of the present invention are achieved by a seal arrangement which has a seal element with at least one seal lip and at least one support ring with which the seal element is supported, wherein the support ring at at least one peripheral point has at least one notch which weakens the annular cross section.

### BRIEF DESCRIPTION OF THE FIGURES

FIG. 1 shows a radial section through a seal arrangement and

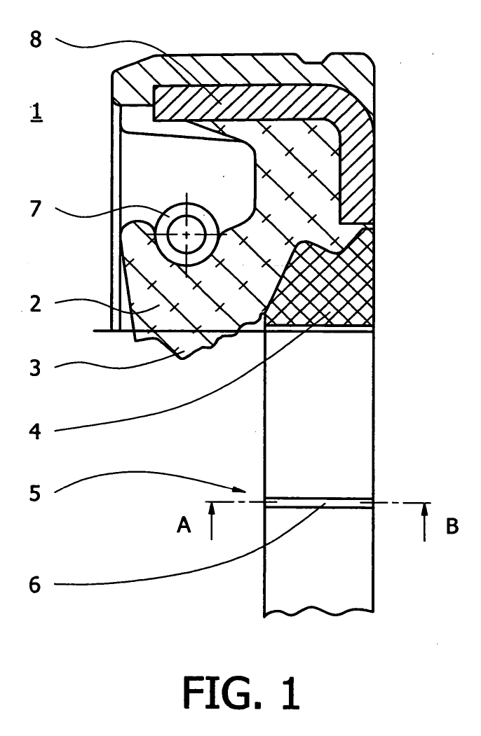

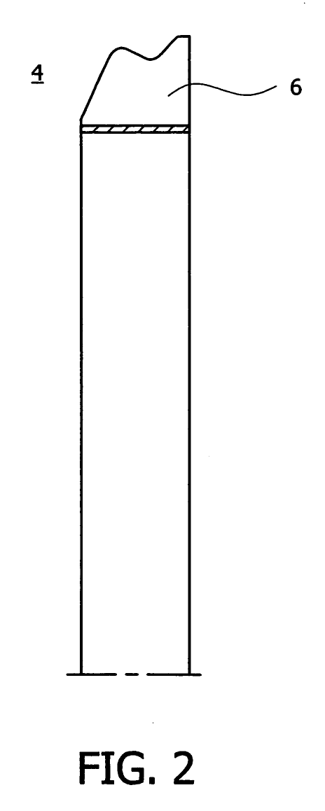

FIG. 2 shows the support ring of the seal arrangement in the section A-B (see FIG. 1) in which the following members illustrate the corresponding elements:
1 seal arrangement
2 seal element
3 seal lip
4 support ring
5 peripheral point
6 notch
7 annular helical spring
8 stiffening ring

### DETAILED DESCRIPTION OF THE PREFERRED EMBODIMENTS OF THE INVENTION

In the present invention, the support ring at least at one peripheral point has at least one notch which weakens the annular cross section: The notch preferably forms a predetermined breaking point on the support ring.

Advantageously, at least one notch is made such that it extends over at least 80% of the cross sectional area of the support ring. This means that a considerable weakening of the remaining cross section at least at one peripheral site occurs due to the notch made in the support ring so that the ring when it is installed can be broken very easily while the aforementioned disadvantages are avoided. It can also be easily provided that the notch is made such that it extends over more than 95% of the cross sectional area of the support ring.

It is also possible for there to be several notches distributed equidistantly over the periphery of the support ring.

The support ring preferably comprises a plastic which is able to be broken very easily, especially polyamide. It can be solid plastic or it may contain spherical fillers (not shown) of a suitable material, e.g., glass balls, to improve the form stability in a conventional manner. Such glass balls can be, for example, spheres of about 40 to 60 micrometers in diameter. The particular type of plastic can be easily determined by the skilled artisan.

The (at least one) notch on the peripheral point of the support ring therefore represents a predetermined breaking point which during installation of the seal arrangement and especially when the seal arrangement is being slipped over the protective sleeve the support ring, breaks easily when it is being widened by radial forces, and returns to its original shape after overcoming the widened diameter in the area of the protective sleeve.

The advantage which is achieved with the invention is that a closed support ring is produced, which ring can then be easily handled; when installed by means of an automatic installation device the support rings can be easily separated and installed. During the installation process, the support ring can be easily broken open in order to move it into its final installation position. After installation there is again a largely closed support ring in the seal arrangement. The support ring sits more securely in the seal arrangement than the existing approaches, and the support of the seal element by the support ring is also optimum.

One embodiment of the invention is described in the drawings. FIG. 1 shows a seal arrangement 1 which has a seal element of elastomer material. The seal element 2 has a seal lip 3 which faces the shaft which is to be sealed and which is not shown. So that the seal lip 3 securely adjoins the shaft and seals it, conventionally there is an annular helical spring 7. The seal element 2 is located on a metallic stiffening ring 8 which has a L-shaped contour in cross section.

The support ring 4 is designed to securely hold and to support the area of the seal element 2 adjacent to the seal lip 3 in operation. There is a slight gap to the shaft which is not detailed so that upon axial loading no material of the seal element can be pressed through the annular gap between the support ring 4 and the shaft. The support ring 4 is preferably made of a polyamide which can be used either in solid form and provided with spherically made glass balls as a filler.

In order to enable the arrangement to be slipped over the increased diameter on the shaft when the seal arrangement is being installed, which is not a problem for the elastic material of the seal element 2 itself, the support ring 4 has a notch 6 at one peripheral point 5. This notch 6 is especially apparent in FIG. 2, where the section A-B as shown in FIG. 1 is sketched. It can be recognized that the support ring is weakened at the peripheral point 5 to a considerable degree, i.e. notched, so that only the area shown cross-hatched in FIG. 2 constitutes a material connection of the annular body at the peripheral point 5.

It is therefore easily possible, as a result of the predetermined breaking point which is formed in this way, to break the support ring during installation, to push it over the point on the shaft with the increased diameter, and afterwards to move it into the end position, the breaking point being re-assembled. Since generally the support ring 4 can be broken without fragments, the original contour is restored after the support ring 4 is rejoined so that the ring 4 as before offers optimum support for the seal element 2.

After installation, therefore again there is a closed ring 4 which can easily perform its function as a support ring.

It has proven effective to make the notch 6 as a radially extending slit which has a width of 0.3 millimeter. The gap is generally in the range between 0.1-1 millimeter. Preferably the notch 6 extends so far into the material of the support ring 4 at the peripheral site 5 that most of the cross section that is, preferably at least 80%, most preferably at least about 95%, is affected by the notch 6. As can be seen in FIG. 2, here far more than 90% of the original cross section has been removed by the notch 6; only the cross-hatched surface area which is small relative to the entire annular cross sectional area constitutes the connection of the annular body at the peripheral point 5.

As can be seen in FIG. 1, in the illustrated embodiment, the end of the L-shaped stiffening ring 8 borders the radially outer end of the support ring 4. Alternatively it can also be provided that the stiffening ring 8 as shown in FIG. 1 is located farther to the right relative to the seal arrangement 1 and the flank of the stiffening ring 8 which extends radially to the inside is lengthened such that it extends radially around the support ring 4. This can result in that the flank of the stiffening ring 8 which runs radially to the inside represents an axial stop surface for the support ring 4. This configuration has proven very advantageous in some steering mechanism seal systems.

The principles, preferred embodiments and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art without departing from the spirit of the invention.

1. Seal arrangement which has a seal element with at least one seal lip and at least one support ring with which the seal element is supported, wherein the support ring at at least one peripheral point has at least one notch which weakens the annular cross section.

2. The seal arrangement of claim 1, wherein the notch forms a predetermined breaking point on the support ring.

3. The seal arrangement of claim 1, wherein at least one notch extends over at least 80% of the cross sectional area of the support ring.

4. The seal arrangement of claim 1, wherein there are several notches distributed equidistantly over the periphery of the support ring.

5. The seal arrangement of claim 1, wherein the support ring is made of plastic.

6. The seal arrangement of claim 5 wherein the plastic is a polyamide.

7. The seal arrangement of claim 5, wherein the support ring is a solid plastic.

8. The seal arrangement of claim 5, wherein the support ring is a plastic containing spherical fillers.

9. The seal arrangement of claim 3 wherein there are several notches distributed equidistantly over the periphery of the support ring.
